(19) United States
(12) Patent Application Publication
(10) Pub. No.: US 2003/0072862 A1
(43) Pub. Date: Apr. 17, 2003

(54) Extended shelf life bakery composition and bakery products

(76) Inventors: Terry Lynn Pruden, Belleville, IL (US); Bassey Ogban Ekpo, O'Fallon, MO (US); Feng Guan, Chesterfield, MO (US); Douglas Alan James, Mattoon, IL (US); Alan Duane Guyon, Toledo, IL (US)

Correspondence Address: Patrick W. Rasche, Armstrong Teasdale LLP, Suite 2600, One Metropolitan Sq., St. Louis, MO, 63102-2740, US

(21) Appl. No.: 10/247,267

(22) Filed: Sep. 19, 2002

Related U.S. Application Data
(60) Provisional application No. 60/323,465, filed on Sep. 19, 2001.

(51) Int. Cl. A21D 10/00

(52) U.S. Cl. 426/549

(57) ABSTRACT

A bakery product composition providing a baked product having an extended shelf life comprising a dough comprising flour, yeast (optional), water and an extended bakery shelf life composition comprising an effective amount of at least one salt of propionic, sorbic, phosphoric, citric, acetic, lactic and benzoic acid, an effective amount of least one of moisture retention composition comprising at least one of guar gum, Arabic gum, xanthan gum, carboxymethylcellulose and (c) an effective amount of at least one enzyme selected from an amylase, protease and pentosanase. The amount of said shelf life extending composition present is that amount which in an effective combination comprising (a), (b) and (c) results in a shelf life extended beyond fourteen days for a baked product prepared from said dough composition.

### BACKGROUND OF THE INVENTION

This invention relates generally to food preservation and more particularly, this invention relates to an extended shelf life bakery product composition, an extended shelf life (fresh) bakery dough composition and a method for extending the shelf life of bakery dough compositions.

Bakery products (baked goods) are a highly desired food product consumed by persons and enjoyed as a food. Baked products may be purchased at a store or a bakery as fresh, frozen and refrigerated. People eat bakery products because of a highly desired taste, organoleptic quality and texture of the bakery product. Bakery products have been a mainstay in humans' diet for thousands of years providing essential elements needed for life.

However some bakery products are displayed or stored on grocer's or baker's shelves or are stored in the home for various length periods of time as fresh or refrigerated after baking. Such storage time (shelf storage) is relatively short duration presently so that the actual total time spent in storage after baking does not exceed the stated (package marked) shelf-life of the product. Typically this known shelf storage time ranges from about two days to about fourteen days.

To a large extent shelf life is set by bakers, manufacturers and grocers. Shelf life is generally the window of time that a food item retains its quality taste, texture and nutritional value. Typically shelf life is based on safety, quality and nutrition considerations.

Extended shelf life is highly desired and is determined largely by environmental considerations such as oxygen, moisture and heat exposure of the baked product. Excessive amounts of oxygen, moisture and heat contacting the baked product will cause loss of nutritional value and the presence of off flavors, odors and rancidity.

Thus it is highly desired to be able to provide an extended shelf life for a fresh or refrigerated bakery product (i.e having extended microbial stability) such as on a store or market shelf, bakery shelf, home storage area or display counter for more than about sixteen days.

### BRIEF DESCRIPTION OF THE INVENTION

In one aspect, a bakery product composition is provided that comprises a dough comprising flour, water, table salt and optionally a leavening agent and containing a shelf life preserving composition comprising (a) an effective amount of at least one salt of propionic, sorbic, phosphoric, citric, acetic, lactic and benzoic acid, (b) an effective amount of at least one of guar gum, Arabic gum, xanthan gum and carboxymethylcellulose and (c) an effective amount of at least one enzyme selected from amylase, protease, and pentosanase and wherein the effective amount present is an amount which in an effective combination results in a shelf life extended beyond sixteen days for a bakery product prepared from the dough composition.

In another aspect an extended shelf life preserving composition is provided that is useful in a bakery product that comprises an effective amount of at least one salt of propionic, sorbic, phosphoric, citric, acetic, lactic and benzoic acid, an effective amount of at least one of guar gum, Arabic gum, xanthan gum and carboxymethylcellulose and an effective amount of at least one enzyme selected from an amylase, protease, and pentosanase.

In another aspect, an extended shelf life bakery product is provided that comprises a bagel having shelf life greater than sixteen days.

In another aspect, a bakery product composition is provided wherein the effective amount of the total of (a), (b) and (c) ranges from about 0.21 to about 6 parts by total weight dough.

In another aspect, a bagel is provided comprising an extended shelf life additive package therein which extends the shelf life of a fresh bagel prepared therefrom to between about sixteen days and twenty-six days.

In another aspect, a bagel is provided wherein the shelf life of the bagel is from about sixteen days to about twenty-six days.

In another aspect, a method for extending the shelf life of a bakery composition comprises adding to a dough of a bakery product a shelf life preserving composition comprising an effective amount of at least one salt of propionic, sorbic, phosphoric, citric, acetic, lactic and benzoic acid, an effective amount of at least one of guar gum, Arabic gum, xanthan gum and carboxymethylcellulose and an effective amount at least one enzyme selected from an amylase, protease, and pentosanase.

In another aspect a method for preserving the shelf life of a bakery composition comprises adding to a dough of a bakery product a shelf life extending composition comprising an effective amount of at least one salt of propionic, sorbic, phosphoric, citric, acetic, lactic and benzoic acid, an effective amount of at least one of guar gum, Arabic gum, xanthan gum and carboxymethylcellulose and an effective amount of at least one enzyme selected from an amylase, protease, and pentosanase.

A method of extending the shelf life of a dough based composition comprises adding to said dough a shelf life extending additive composition comprising (a) an effective amount of at least one salt of propionic, sorbic, phosphoric, citric, acetic, lactic and benzoic acid; (b) an effective amount of at least one of guar gum, Arabic gum, xanthan gum and carboxymethylcellulose; and (c) an effective amount of at least one enzyme selected from an amylase, protease, and pentosanase.

### DETAILED DESCRIPTION OF THE INVENTION

In an embodiment, a bakery product composition comprises a shelf life extending and preserving composition whereby a bakery product (i.e. a dough based product) is imparted with an extended shelf life from about sixteen days to about twenty-six days. In an embodiment, the shelf life extending composition is admixed and added to the unbaked dough or to a partially baked dough. The dough is baked whereupon the extended shelf life is manifested in the baked product. In an embodiment, the shelf life extending composition comprising (a) an effective amount of at least one salt of propionic, sorbic, phosphoric, citric, acetic, lactic and benzoic acid, (b) an effective amount of at least one of guar gum, Arabic gum, xanthan gum and carboxymethylcellulose and (c) an effective amount of at least one enzyme selected from amylase, protease, and pentosanase is integrated and admixed into an unbaked or partially baked dough prior to, at or during baking. After baking or partial baking, the extended shelf life from about sixteen days to about twenty six days is manifested.

Nonlimiting useful examples of a dough based product include any bakeable food which is based on a dough and a baked food prepared therefrom including but not limited to bagels, English muffins, waffles, bread, French toasts, buns, doughnuts, quick bread, French bread, pumpernickel bread, sourdough bread, pancake, pizza crust, breadstick, brioche, rolls, cinnamon rolls, cookies, biscuits, crepes, croissants, shells, Danish dough, pie and tart shells, puff pastry, pastry, strudels, scones and vol-au-vent, corn yeast rolls, beer rolls, buttercakes, frosting, fudge, cakes, phyllo dough, yeast breads and cereal based food products.

As used herein, the term “baking” includes the process of applying effective energy in the form of heat utilizing an oven or suitable heating transfer apparatus capable of providing and directing heat to a dough based product to convert flour, water (and optionally yeast) present in the dough product to a baked product as a result of the effective and sufficient application of heat to the product.

As used herein, the term “heat energy” includes energy including convection, radiation, and/or microwave energy applied in a form effective and sufficient to accomplish baking of a product. Baking energy may be imparted to the product by a combination of one or more of convection, radiation and/or microwave energy application means such as an oven or convection and radiation application means. Baking mechanisms including electric, gas, wood and solar stoves, ovens, and furnaces may be employed if desired to achieve the desired temperature level. An open fire or hearth may be employed as a baking mechanism. The amount of time employed in cooking will be determined from a number of factors including the amount of dough and composition to be baked, the water content and other variables of the baking operation.

As used herein, the term “oven” includes any heated environment or enclosure capable of providing and applying heat energy to an uncooked or unbaked item to convert that item to a baked product. Typically in such an enclosure sufficient heat energy is supplied for baking, heating and drying a dough based product to convert an unbaked or partially baked dough to a baked form. One or more ovens may be employed if desired, for example, in a series fashion or parallel fashion.

Various illustrative useful types of ovens and suitable heating and baking apparatus, kneaders, mixing equipment and other apparatus, useful in preparing and baking a dough based product to form a dough and to form a baked product from dough are disclosed in Perry's Chemical Engineers' Handbook, Seventh Edition, Robert H. Perry and Don W. Green, ISBN0-07-049841-5, 1997.

As used herein, the term “dough based product” includes a dough containing compositions, unbaked, partially baked and baked dough compositions which comprise flour, water (and optionally yeast or optionally a chemical leavening agent) and which form a desirable baked product when subjected to effective amounts of heat energy sufficient to impart baking to the product.

As used herein, the term “dough” includes dough based flour, i.e., having at least a substantial flour component, wherein the flour component is flour made or derived from grains such as wheat, oats, barley, rye, millet and corn mixed with water. Optionally, salt, eggs, sugars, fruits and other baking additives may be added to give bakery products flavor, change its texture or increase its nutritional value.

In an embodiment, bakery products are made by use of a leavening agent or without a leavening agent. In a further embodiment, leavening is accomplished by using yeast or chemical leaving agents such as baking soda, baking powder, or sodium pyrophosphate in the dough to effect a rise in dough.

As used herein, the term “croissant” includes raw, pre-baked and triangle croissants.

As used herein the term “shelf life” means that the measurement of shelf life is measured starting from the day of baking and is measured forward in time generally in terms of days, from that baking day. An extended shelf life of about sixteen days to twenty six days is intended to mean a shelf life of sixteen days to about twenty six days after baking.

In an embodiment, the bakery composition further comprises batter, unbaked, dough, proofed/pre-proofed dough, pre-baked dough, partially baked dough, and baked dough products. Also included are bakery products stored under refrigerated and ambient conditions.

The novel bakery dough herein comprises flour, optionally yeast, and water to which has been added at least one salt of an acid selected from the group consisting of propionic, sorbic, phosphoric, citric, acetic, lactic and benzoic acid.

An illustrative bakery composition (recipe) is shown in Table I following with illustrative components shown in illustrative ranges in parts by weight.

TABLE I

| Component | Broad Range | Narrow Range |
|---|---|---|
| Flour | 30-65 | 45-60 |
| Water | 20-65 | 30-50 |
| Leavening Agent | 0-4 | 1-3 |
| (optional) | | |
| Ordinary Table Salt | 0.1-3 | 0.5-1.5 |
| (a) | 0.15-3 | 0.7-2 |
| (b) | 0.05-2 | 0.1-1.5 |
| (c) | 0.01-1 | 0.05-0.8 |
| Other Optional | 0.8-16 | 3-12 |
| Ingredients or | | |
| Additives | | |
| Total | 100 | 100 |

Any suitable flour (including all purpose and enriched flours) may be employed herein which is sufficient to provide protein(s) to form gluten and give rise. However, an enriched wheat flour is generally utilized to provide a higher protein content and provide more gluten to baked bread and to bakery products.

Methods for preparing a baked product are hereinafter described with particularity to bread and bagel merely as an illustratively embodiment of baking a baked product. It is to be understand that those presently available techniques for baking English muffins, waffles, bread, French toasts, buns, doughnuts, quick bread, French bread, pumpernickel bread, sourdough bread, pancake, pizza crust, breadstick, brioche, rolls, cinnamon rolls, cookies, biscuits, crepes, croissants, shells, Danish dough, pie and tart shells, puff pastry, pastry, strudels, scones and vol-au-vent, corn yeast rolls, beer rolls, buttercakes, frosting, fudge, cakes, phyllo dough, yeast breads and cereal based food products may be employed. It is further understood that a variety of recipes exist which include for a plethora of ingredients which may be employed with this novel shelf life extending and preserving composition. Various toppings may be employed to enhance flavor, appeal and attractiveness.

In an embodiment, flour comprises wheat flour which is most commonly whole wheat and white. White flour is milled from the endosperm of wheat. Enriched flour may be used whereby supplements including extra vitamins and minerals. have been added to white flour. Wheat flour contains glutenin and gliadin proteins that combine with water to form gluten which allows the dough to stretch and trap gas and air bubbles.

Other illustrative useful flours include those from grains, oilseeds, and legumes such as oilseeds (soybean, flax, safflower, peanut, rapeseed, coconut, cottonseed, and sesame) and legume flours (navy bean, lupine, lima bean, chickpea, cowpea, fababean, pigeon pea, and lentil). In an embodiment, the flour comprises bean flour, peanut flour, sunflower flour, buckwheat flour and soy flour.

Tap or distilled water may be employed. Orange juice may be employed as a source of water as well as other suitable fruit juices.

Illustrative useful yeasts herein include commercial yeast, Baker's yeast, Fleischman's® yeast and include yeasts which have the capability to raise dough and include related species and strains of Saccharomyces cerevisiae. Both regular active dry and rapid-rise dry yeast can be employed.

As used herein, the term “baking soda” includes sodium bicarbonate. Baking powder may be used as it comprises baking soda with an acid which is mixed with either starch or flour and cream of tartar or other acid forming substance such as anhydrous sodium aluminum sulfate.

Other illustrative useful leavening agents include sodium acid pyrophosate, Na₂H₂P₂O₇, also referred to known as disodium pyrophosate and disodium dihydrogen pyrophosate.

Nonlimiting illustrative useful baking powders include those which comprise sodium acid pyrophosate, sodium bicarbonate, corn and/or wheat starch, monocalcium sulphate, and calcium sulphate; sodium bicarbonate, cornstarch, aluminum sulphate and sodium sulphate, monocalcium sulphate, calcium sulphate; sodium acid pyrophosphate, sodium bicarbonate, cornstarch, monocalcium sulphate, calcium sulphate; and corn starch, monocalcium sulphate and sodium bicarbonate. (Arm & Hammer® Baking Soda, Church & Dwight Co. Inc., 469 North Harrison Street, Princeton, N.J. 08543 USA)

In an embodiment, sourdough bread is a useful dough based product and is made using a combination of wild yeast (often Candida milleri) and an acid-generating bacteria (Lactobacillus sanfrancisco sp. nov).

In addition to different flours, additional ingredients which may be added to dough base products to impart different flavors and textures include eggs and sugar. Fats and oils (also called shortening), can be added to bread dough to create a tender, richer bread with a finer consistency if desired. Other useful illustrative ingredients include raisins, almonds, sesame seeds, and poppy seeds, and herbs and spices, such as cumin and cinnamon.

Leavening is an option in preparing a bakery product to produce rise by physical and chemical means. The leavening selected is usually dependent on the balance and kind of ingredients in the formula, and the handling and processing involved.

In an embodiment, non-iodized table salt such as sodium chloride and a wide variety of flavorings are used to obtain the type and variety of product wanted.

Bread is generally made from dough by mixing, kneading, rising dough, shaping and baking the dough in a variety of processes.

In an embodiment, flour is admixed with yeast, and liquid ingredients usually water and any additional ingredients such as salt, sugar, and shortening are admixed therewith to form dough. The dough will gradually thicken upon stirring and after the dough is difficult or too thick to stir, the dough may be kneaded by repeatedly pressing, folding, massaging and turning the dough. In an embodiment, Fleischman's® yeast or Baker's yeast may be employed as yeast.

Kneading of dough is accomplished by pressing the dough against a rigid surface for example hand or machine pressing dough against a resistance such as a counter or table top or pressing dough against or on a stone. If desired, kneading may be carried out in a kneading machine wherein kneading is accomplished by action of metal or plastic blades against the dough such as in a bread making machine.

An effective amount of one or more salts of propionic, sorbic, phosphoric, citric, acetic, lactic and benzoic acid is employed and is added to the dough. One or more of these salts may be employed as in an admixture to provide an effective amount. While the acid may be added to the dough composition, the salt form is preferred for enhanced efficaciousness such as for example, a sorbate, acetate or lactate.

In an embodiment, salts include alkali metal salts such as sodium and potassium salts and alkaline earth metal salts such as calcium and magnesium of the aforementioned acids. In an embodiment such salts are water soluble, dissociate and are of food grade quality.

Illustrative useful nonlimiting salts include sodium propionate, sodium sorbate, sodium phosphate, sodium citrate, sodium acetate, sodium lactate, sodium benzoate, potassium sorbate, potassium phosphate, potassium citrate, potassium acetate, potassium lactate, potassium benzoate, potassium sorbate, potassium phosphate, calcium propionate, calcium sorbate, calcium phosphate, calcium citrate, calcium acetate , calcium lactate, calcium benzoate, magnesium propionate, magnesium sorbate, magnesium phosphate, magnesium citrate, magnesium acetate, magnesium lactate, mangesium benzoate, magnesium sorbate and magnesium phosphate and mixtures thereof.

In an embodiment, an effective amount of components (a) an effective amount of at least one salt of propionic, sorbic, phosphoric, citric, acetic, lactic and benzoic acid, (b) an effective amount of at least one of guar gum, Arabic gum, xanthan gum and carboxymethylcellulose and (c) an effective amount of at least one enzyme selected from amylase, protease, and pentosanase are admixed with the dough.

Typically an effective amount of (a) an effective amount of at least one salt of propionic, sorbic, phosphoric, citric, acetic, lactic and benzoic acid, (b) an effective amount of at least one of guar gum, Arabic gum, xanthan gum and carboxymethylcellulose and (c) an effective amount of at least one enzyme selected from amylase, protease, and pentosanase is in the range from about 0.21 to about 6 parts by weight dough.

These components include an effective amount of at least one of guar gum, gum Arabic, CMC and xantham gum.

Guar gum (also called guaran) is extracted from the seed of the leguminous shrub Cyamopsis tetragonoloba. Gum Arabic is a dried exudate obtained from the stems and branches of Acacia senegal (L.) Willdenow or closely related species of Acacia (fam. Leguminosae). Gum arabic also is called gum talha as it comprises high-molecular weight polysaccharides and their calcium, magnesium, and potassium salts, which on hydrolysis yield arabinose, galactose, rhamnose, and glucuronic acid. (CAS No. 9000-11-7, 9000-32-4 also known as sodium carboxy-methyl cellulose and sodium cellulose glycolate carimethose).

Carboxymethylcellulose (CMC) is a derivative of cellulose made from alkali and chloroacetic acid.

Xanthan gum is manufactured and sold by CP Kelco of Wilmington, Del. USA as the Keltrol (R) family of products, Rhodia Food Ingredients of Cranbury, N.J. as the Rhodigel family of products, and Archer Daniels, Midland Company of Decatur, Ill. USA.

Xanthan gum is a microbial polysaccharide produced by a pure culture aeorbic submerged fermentation of xanthomonas campestris. Xanthan gum is comprised of a backbone of 1,4 linked D-glucose with trisaccharide side chains on alternating anhydroglucose units. The side chains comprise a glucuronic acid residue between two mannose units.

Examples of useful xanthan gums include those such as Keltrol, Keltrol F, Rhodigel, Keltrol T, Keltrol R D, and Rhodigel Clear. Xanthan gum is typically available as a powder of varying suitable particle sizes.

Typical enzymes employed as a component (c) include one more of a hydrolytic, oxidizing, and reducing enzyme including one or more of an amylase, including bacterial amylase, protease and pentosanase and mixtures thereof.

Useful amylases include any enzyme which degrades a polysaccharide and includes diastes such as alpha-amylase and beta-amylase and amlopectin, the branched form.

Useful proteases include carboxypeptidase, elastase, trypsin, L-cysteine, chymotrypsin, papain, subtilisin, thermolysin, pancreatin, peptidases and mixtures thereof and an enzyme which breaks a peptide or polypeptide bond.

Useful pentosanases include pentosanse such as that prepared from Trichodema sp. and which contains high xylanase activity together with beta-1,3-gluconase, galasto-mannase and cellulose.

Useful proteases, amylases and pentosanases are disclosed in Biochemistry, Third Edition, Lubert Stryer, W. H. Freeman and Company, NY, ISBN 0-7167-1920-X and −7. (Also Proteases.net, http://www.proteases.net/)

A pH adjustment agent is typically included in the bakery composition. Useful pH adjustment agents include but are not limited to mono calcium phosphate and acid salts. Phosphates may be employed as a pH adjustment agent. Mono, di and triphosphates may be employed. These are typically employed as their alkali metal or alkaline earth metal salt(s) or as mixtures thereof.

If desired, monocalcium phosphate may be employed in the composition to adjust pH of the dough composition to a desired pH range wherein the shelf life enhancing additive package provides enhanced shelf life beyond fourteen days shelf life. Typically the pH is adjusted to or maintained in the range from about 3.8 to about 6.5 and preferably from about 4.5 to about 5.5.

Sugars, dough conditioners, oxidizing agents and other additives may be admixed in the bakery composition. In an embodiment, various amounts, types and combinations of such additives may be employed depending on the type of bakery product, the texture desired and organoleptic quality desired.

Any suitable sugar may be employed in the composition including syrups such as corn syrup. Conventional high fructose corn syrup, (sugar) yeast (creamed yeast, or creamed yeast with water removed), and mono and diglycerides may be employed from any conventional source.

Illustrative useful sugars in the composition include but are not limited to granulated sugar, regular sugar, extra fine and fine sugar, fruit sugar, baker's special, superfine, ultrafine, bar sugar, confectioners (or powdered) sugar, course sugar, sanding sugar, brown sugar (turbinando), light and dark brown sugar, muscovado or Barbados sugar, free flowing brown sugar, liquid sugars (liquid sucrose and amber liquid liquid sucrose), invert sugar, liquid invert and total invert liquid sugar and mixtures thereof. Useful sugars including reducing and nonreducing sugars. In an embodiment, sugar (common table) is employed. Sugar includes fructose and glucose based sugars.

Illustrative useful monoglycerides, diglycerides and triglycerides in the composition include those derived from glycerol which are also known as triaclglycerides (triacyl-, diacyl- and monoacylglycerol). Also useful herein are lipids having one or two long-chain alkyl groups joined by an ether linkage to glycerol, the other(s) chain(s) being esterified with conventional fatty acid(s). These alkyl ethers of glycerol are described with their acyl counterparts (monoalkyl glycerols and alkyl-diacylglycerols).

Normal amounts of table salt (sodium chloride-NaCl) typically employed in the dough are in the range from about ¼ teaspoon to about 1 teaspoon per cup of flour.

Novamyl® enzyme, an amylase, sold by Novo Nordisk, Franklinton, N.C., USA or Novo Nordisk Pharmaceuticals, Inc., 100 College Road West, Princeton, N.J. 08540 USA is a useful enzyme.

A useful dough conditioner (oxidizing agent) which may be employed comprises Special Enhanced SC, available from Cain Food Industries, P.O. Box 35066, Dallas, Tex., 75019-0066.

If desired, mixtures of glycerides and alkali earth metal stearates may be employed in the composition such as that available as Panodan 205K (diacetyl tartaric acid ester of monoglycerides and calcium stearate)—supplied by Danisco Coultor USA, Inc., 201 New Century Parkway, New Century, Kans., 66031, USA; or Danisco Cultor, Langebrogade 1, P.O. Box 17, DK-1001, Copenhagen, Denmark.

Illustrative useful stearates include sodium and potassium stearate and calcium and magnesium stearate and mixtures thereof.

Vital wheat gluten is preferably employed. Vital wheat gluten is prepared from starches by a combination of centrifuge and subsequent washings and screenings.

Various bakeable fillings may be added in the dough composition prior to baking if desired. Illustrative useful fillings include fruit fillings including cherries.

In an embodiment, illustrative bagel dough compositions of this invention include compositions (recipes) shown in the Table II following:

TABLE II

| Ingredients | Ranges (%) | | |
|---|---|---|---|
| Flour | 50 | — | 65 |
| Water | 20 | — | 40 |
| Sugar | 0.5 | — | 8 |
| Yeast | 0.5 | — | 4 |
| Salt | 0.2 | — | 3 |
| Mono & Diglycerides | 0.05 | — | 2 |
| Gluten | 0.1 | — | 2 |
| Sorbate | 0.05 | — | 1 |
| Propionate | 0.05 | — | 1 |
| Panodan | 0.05 | — | 2 |
| Phosphate | 0.05 | — | 1 |
| L-Cysteine | 0.05 | — | 1 |
| Dough conditioner | 0.05 | — | 1 |
| Gum | 0.05 | — | 2 |
| Enzymes | 0.01 | — | 1 |

The process of preparing an extended shelf life bakery composition such as an extended shelf life bagel comprises admixing batched dough ingredients for an amount of time sufficient to develop a consistant textured dough. Dough preparation is generally done first in making yeast based bakery products such as bread. Bread making involves mixing, kneading, and rising the dough, shaping and baking the unbaked bakery product or bread.

In an embodiment, bread dough is made by mixing flour, yeast (optional), water and table salt (NaCl) to form an initial bread dough. In an embodiment, the initial dough is kneaded by repeatedly kneading, pressing, turning, massaging and folding the dough. The dough is allowed to stand for a few hours so the bread rises. The kneading, pressing, turning, massaging and folding may be repeated if desired after the initial rise and as often as desired to effect a desireable rise.

A slicing device such as a knife or a slicing machine is used to slice the dough into loaves and place the loaves into baking pans or suitable baking apparatus. Slicing may be done manually or automatically by machine. The loaves are run through a temperature- and humidity-controlled chamber, where they rise again. In an embodiment, the loaves pass through a hot-air convection oven where they are baked.

Automated equipment may be used and the dough placed into electric mixers that mix and knead batches of dough. The dough is proofed in temperature and humidity controlled chambers. The dough is shaped and placed in steam-injected or convection ovens, then cooled and mechanically sliced.

Dough ingredients include flour, water, yeast (optional) and table salt. An effective amount of at least one salt of propionic, sorbic, phosphoric, citric, acetic, lactic and benzoic acid is added along with the texture enhancement composition to form the initial dough.

It is understood that various admixtures of (a) an effective amount of at least one salt of propionic, sorbic, phosphoric, citric, acetic, lactic and benzoic acid, (b) an effective amount of at least one of guar gum, Arabic gum, xanthan gum and carboxymethylcellulose and (c) an effective amount of at least one enzyme selected from amylase, protease, and pentosanase, including combinations thereof and as individual components thereof, may be added to the dough or conversely the dough may be added to an admixture of various components of (a), (b) and (c). Generally admixing of ingredients is carried out to an effective and adequate degree of mixing such as thorough mixing, in a process of preparing a dough and a baked product therefrom.

After the initial dough preparation, the dough is separated (by cutting) for example into pieces of dough of a desired weight and rolled into a mass, preferably a ball shape. The dough is proofed in an intermediate proofer (under ambient conditions) and transported to a bagel making machine.

In proofing, the bakery product is subject to a warm temperature such as about 90° F.—about 95° F. and about 80% —about 85% relative humidity for an effective proofing time in a proofer. It is understood that proofing time will vary with size of product, cabinet temperature and humidity, and composition and age of dough. Most bakery products require proofing time between about 30 minutes and about 50 minutes, or until the product is about doubled in size.

Typically an illustrative proofer comprises a box or chamber wherein the temperature and relative humidity can be controlled. Typically the bagel making machine comprises a cup and mandrel.

A slow delivery time from the intermediate proofer to the bagel machine is preferred to allow the dough to relax which prepares the dough for proofing. During this stage, the product is formed into the desired shape of a bagel. Generally the elapsed time for a slow delivery is in the range from about 5 to about 15 minutes.

A useful illustrative bagel machine comprises a Thompson Bagel machine available from Thompson Bagel Machine, 8945 Ellis Avenue, Los Angeles, Calif. 90034-3380.

Bagels may be prepared in a number of ways. In an enbodiment, the dough balls are dropped into a cup and mandrel bagel former where the dough is rolled into a ring around a center mandrel. Uncooked bagels are conveyed to indexing equipment where the uncooked bagels are prepared for further proofing (raising).

Uncooked bagels are processed in a final proofer where the uncooked bagels are exposed to warm and humid conditions which causes the yeast to react with other ingredients and raise the dough by release of carbon dioxide.

Upon exiting the final proofer, bagels are conveyed through a cooker where they are conveyed through boiling water and cooked on both sides. Typically an illustrative cooker comprises a water bath and a conveyor.

In an embodiment, cooked bagels are conveyed through a dryer where gas fired burners dry the outside of the bagel in preparation for baking.

Typically the dryer comprises a belt conveyor and a hot air blower. The bagels are generally dried to a moisture context so that no stick issues are presented for baking.

The dried bagels are then passed through an oven where they are exposed to varying burner settings to accomplish baking. Typically the oven comprises a belt conveyor and a heating unit.

The baked bagels are quick cooled to about 75° F. to about 85° F. to form cooled bagels. The cooled bagels are then sliced in a slicing device and passed through a metal detector and mechanically bagged for delivery to a point of use.

The bagel product is fresh at this time and is consumable by a person as a nutritious food. The fresh bagel of this invention provides a good taste and an extended shelf life in the range from about sixteen days to about twenty six days.

The intermediate proofing is carried out for about 5 to about 15 minutes at a temperature from about 55° to about 85° F. Final proofing is carried out at a temperature from about 50% to about 95% relative humidity and about 55° F. to about 115° F. from about 10 to about 50 minutes.

Cooking follows at about 200° F. to about 212° F. for about 1 to about 5 minutes. The oven is operated at about 300° F. to about 650° F. for about 5 to about 25 minutes.

The air temperatures to the cooler is operated at about 45° F. to about 85° F. from about 15 to about 60 minutes.

The freezer is operated at about −30° F. degrees to about −20° F.

The amount of residence time in the process steps of preparing the bagel as illustratively aforedescribed is sufficient to effectively carry out and accomplish each respective aspect of the process. Those of skill in the art will readily understand equipment which can be suitably employed to prepare a baked product of this invention after reading this specification and claims.

The amount of shelf life extending additive package employed is that amount which when employed in a combination results in an increase in the shelf life of the fresh and refrigerated bakery product in excess of that employed to achieve a fourteen day shelf life.

The amount of (a) an effective amount of at least one salt of propionic, sorbic, phosphoric, citric, acetic, lactic and benzoic acid, (b) an effective amount of at least one of guar gum, Arabic gum, xanthan gum and carboxymethylcellulose and (c) an effective amount of at least one enzyme selected from amylase, protease, and pentosanase employed is determined by subjecting the fresh or refrigerated bagel containing effective amounts of shelf life extending and preserving composition (a), (b) and (c) to a mold and thereafter measuring the amount of mold accumulated thereon over a period of days after the bagel is placed in contact with the mold. A control is employed.

More in particular, a useful method of evaluating and determining extended shelf life is based on the first observance of mold on a bagel following an inoculation with mold. In such an evaluation, a series of bagels are prepared and are appropriately placed in contact with mold inoculation. Typically a composite of mold is used from a known active mold culture. Organisms are cultured individually on standard laboratory culture media and equal numbers of varieties are combined to form a composite mold culture.

Sleeves of bagels are provided and are inoculated with a selected number of mold spores per gram weight of bagel. An effective inoculation is carried out, such as by injection in a bagel beneath its surface or by placing mold spores on the surface of a top bagel. Inoculated bagels are kept at room temperature from about 73° F. to about 77° F.

Samples of the inoculated bagels are inspected and a mold count is made. While various mediums may be employed, a typical useful medium is potato dextrose agar (PDA) with antibiotics. Typical evaluation conditions include an incubation time of about 5 days, a temperature of about 25° C. and an aerobic atmosphere.

Shelf life of a fresh bagel may be determined by any number of useful shelf life test methods including inoculation and evaluation such as the above which provide a useful method for determining the shelf life of a bagel.

### EXAMPLE

The Example below is provided to illustrate the subject invention and is not included for the purpose of limiting the invention.

The dough composition comprised a composition consistent with that illustrated in Table II.

The bagels were packaged in plastic bags and were inoculated with mold spores. A control was maintained of uninoculated bagels. The inoculum was introduced onto the bagels by injection onto the surface. After inoculation, the bagels were stored at about 73° F.—about 77° F. for a period of days.

Samples of bagels were inspected for visible mold growth until visible mold is present on the inoculated samples. A composite sample was prepared for microbial analysis.

The microbiological stability of a food product was determined by contacting it with spoilage microorganisms. When the level of the organisms does not increase during shelf-life storage, the product formulation is resistant to microbial growth and is considered microbiologically stable.

Table III following shows mold counts of inoculated and uninoculated bagels at viable intervals. Bagels prepared in accordance with this invention were determined to have a shelf life from about sixteen days to about twenty six days according to microbial analysis.

TABLE III

| | |
|---|---|
| Uninoculated Samples | Inoculated Samples |

| | Mold Count | Visual Mold | Mold Count | Visual Mold |
|---|---|---|---|---|
| Week | (cfu/g)* | Analysis | (cfu/g) | Analysis |
| 1 | <10 | 0 | 3,400 | 0 |
| 2 | <10 | 0 | 2,500 | 0 |
| 3 | <10 | 0 | 600 | 0 |
| 4 | <10 | 0 | 310 | 0 |
| 5 | <10 | 0 | 260 | 0 |

*cfu/g: Colony forming units per gram
**35 days satisfactory

While the invention has been described in terms of various specific embodiments, those skilled in the art will recognize that the invention can be practiced with modification within the spirit and scope of the claims.

What is claimed is:

1. A bakery product composition providing a baked product having an extended shelf life, said bakery product composition comprising a dough comprising flour, water, and optionally yeast, said shelf life extending composition comprising:
(a) an effective amount of at least one salt of propionic, sorbic, phosphoric, citric, acetic, lactic and benzoic acid;
(b) an effective amount of at least one of guar gum, Arabic gum, xanthan gum, carboxymethylcellulose;
(c) an effective amount of at least one enzyme selected from an amylase, protease and pentosanase;
wherein the amount of (a), (b) and (c) is an amount which in an effective combination of (a), (b) and (c) results in a shelf life extended beyond fourteen days for a fresh or refrigerated product prepared from said dough composition.

2. A bakery product composition in accordance with claim 1 wherein said bakery product further comprises batter, dough, proofed/pre-proofed, pre-baked, and baked products.

3. A bakery product composition in accordance with claim 2 wherein said bakery product is stored under refrigerated or ambient conditions.

4. A bakery product composition in accordance with claim 3 wherein said effective amount of the total of (a), (b) and (c) is in the range from about 0.21 to about 6 parts by weight dough.

5. A bakery product composition in accordance with claim 4 wherein said effective amount of (a), (b) and (c) ranges from about 0.47 to about 5.9 parts by weight dough.

6. A bakery product composition in accordance with claim 3 wherein said salt comprises an alkali metal salt which is selected from at least one of sodium and potassium.

7. A bakery product composition in accordance with claim 3 wherein said salt comprises an alkaline earth metal which is selected from at least one of calcium and magnesium.

8. A bakery product composition in accordance with claim 3 wherein said acetic and salt is sodium acetate.

9. A bakery product composition in accordance with claim 3 wherein said propionate is sodium propionate.

10. A bakery product composition in accordance with claim 3 wherein said salt is sodium sorbate.

11. A bakery product composition in accordance with claim 5 wherein said shelf life of said baked product is extended to about twenty-six days and said baked product is a bagel.

12. An extended shelf life bakery composition useful in a dough based bakery product, said composition comprising:
(a) an effective amount of at least one salt of propionic, sorbic, phosphoric, citric, acetic, lactic and benzoic acid;
(b) an effective amount of at least one of guar gum, Arabic gum, xanthan gum, carboxymethylcellulose; and
(c) an effective amount of at least one enzyme selected from an amylase, protease and pentosanase, wherein the amount in an effective combination comprising the total amount of (a), (b) and (c) results in a shelf life extended beyond fourteen days for a bakery product prepared from said dough based composition.

13. A bakery product composition in accordance with claim 12 wherein said bakery product further comprises batter, dough, proofed/pre-proofed, par-baked, and baked products.

14. A bakery product composition in accordance with claim 13 wherein said bakery product is stored under refrigerated or ambient (fresh) conditions.

15. A bakery product composition in accordance with claim 14 wherein said effective amount of (a), (b) and (c) is in the range from about 0.284 to about 5.8 parts by weight dough.

16. A bakery product composition in accordance with claim 15 wherein said effective amount of (a), (b) and (c) ranges from about 0.321 to about 5.7 parts by weight dough.

17. A bakery product composition in accordance with claim 16 wherein said effective amount of (a), (b) and (c) ranges from about 0.358 to about 5.6 parts by weight dough.

18. A bakery product composition in accordance with claim 14 wherein said salt comprises an alkali metal salt selected from at least one of sodium and potassium.

19. A bakery product composition in accordance with claim 15 wherein said salt comprises an alkaline earth metal salt.

20. A bakery product composition in accordance with claim 15 wherein said acetic salt is sodium acetate.

21. A bakery product composition in accordance with claim 15 wherein said propionate is sodium propionate.

22. A bakery product composition in accordance with claim 15 herein said sorbic salt is sodium sorbate.

23. A bakery product composition in accordance with claim 15 wherein said shelf life is extended to about twenty-six days.

24. A bakery product in accordance with claims 15 wherein said bakery product is a bagel.

25. A bakery product composition in accordance with claim 12 wherein the amount of shelf life enhancing composition is in the range from about 0.6% to about 2% when ingredients of the dough are expressed on a bakers % basis.

26. A bakery product composition in accordance with claim 25 wherein said amount is from about 0.75% to about 1%.

27. A bakery product composition in accordance with claim 26 wherein the extended shelf life is about sixteen days to about twenty-six days.

28. A bakery product composition in accordance with claim 27 wherein said shelf life is from about twenty one days to about twenty-six days

29. A fresh bagel prepared from a dough formulation having the composition of claim 12 which extends the shelf life of a fresh bagel prepared therefrom to a shelf life from about sixteen days to about twenty-six days.

30. A bagel in accordance with claim 28 wherein said bagel is refrigerated.

31. A bagel in accordance with claim 29 wherein the shelf life of the bagel is in the range from about twenty days to about twenty-six days.

32. An enhanced bagel dough comprising a bagel dough containing a shelf life preserving composition comprising:
(a) an effective amount of at least one salt of propionic, sorbic, phosphoric, citric, acetic, lactic and benzoic acid;
(b) an effective amount of at least one of guar gum, Arabic gum, xanthan gum, carboxymethylcellulose; and
(c) an effective amount of at least one enzyme selected from amylase, protease and pentosanase, wherein the amount of said shelf life extending composition present is that amount which in an effective combination results in a shelf life extended beyond fourteen days for a bagel prepared from said dough composition.

33. A bagel dough in accordance with claim 32 wherein the shelf life of a bagel prepared therefrom has a shelf life from about fifteen days to about twenty-six days.

34. A bakery product composition in accordance with claim 33 wherein said bakery product further comprises batter, dough, proofed/pre-proofed, pre-baked, and baked products.

35. A bakery product composition in accordance with claim 34 wherein said bakery product is stored under refrigerated or ambient conditions.

36. A bakery product composition in accordance with claim 34 wherein said effective amount of (a), (b) and (c) is in the range from about 0.395 to about 5.5 parts by weight dough.

37. A bakery product composition in accordance with claim 36 wherein said effective amount of (a), (b) and (c) ranges from about 0.432 to about 5.4 parts by weight dough.

38. A bakery product composition in accordance with claim 37 wherein said effective amount of (a), (b) and (c) ranges from about 0.469 to about 5.3 parts by weight dough.

39. A method for extending the shelf life of a bakery composition, wherein the method comprises adding to a dough of a bakery product a shelf life preserving composition comprising:
(a) an effective amount of at least one salt of propionic, sorbic, phosphoric, citric, acetic, lactic and benzoic acid;
(b) an effective amount of at least one of guar gum, Arabic gum, xanthan gum and carboxymethylcellulose; and
(c) an effective amount of at least one enzyme selected from an amylase, protease, and pentosanase, wherein the amount of said shelf life preserving composition present is that amount which in an effective combination results in a shelf life preserved beyond fourteen days for a bakery product prepared from the dough composition.

40. A method in accordance with claim 39, wherein said salt is selected from at least one salt of propionic, sorbic, phosphoric, citric, acetic, lactic and benzoic acid.

41. A method in accordance with claim 40 wherein said bakery product further comprises batter, dough, proofed/pre-proofed, par-baked, and baked products.

42. A method in accordance with claim 41 wherein said bakery product is stored under at least one of frozen, refrigerated, and ambient conditions.

43. A bakery product composition in accordance with claim 42 wherein said effective amount of (a), (b) and (c) is in the range from about 0.506 to about 5.2 parts by weight dough.

44. A bakery product composition in accordance with claim 43 wherein said effective amount of (a), (b) and (c) ranges from about 0.543 to about 5.1 parts by weight dough.

45. A bakery product composition in accordance with claim 44 wherein said effective amount of (a), (b) and (c) ranges from about 0.58 to about 5.0 parts by weight dough.

46. A method in accordance with claim 44 wherein said salt comprises an alkali metal salt.

47. A method in accordance with claim 44 wherein said salt comprises an alkaline earth metal salt.

48. A method in accordance with claim 46 wherein said salt is sodium acetate.

49. A method in accordance with claim 44 wherein said propionate is sodium propionate.

50. A method in accordance with claim 44 wherein said sorbic and salt is sodium sorbate.

51. A method in accordance with claim 44 wherein said shelf life of said baked product is extended to about twenty-six days.

52. A method for preserving the shelf life of a bakery composition, wherein said method comprises adding to a dough of a bakery product a shelf life preserving or extending composition comprising:
(a) an effective amount of at least one salt of propionic, sorbic, phosphoric, citric, acetic, lactic and benzoic acid;
(b) an effective amount of at least one of guar gum, Arabic gum, xanthan gum and carboxymethylcellulose; and
(c) an effective amount of at least one enzyme selected from an amylase, protease, and pentosanase, wherein the amount of said shelf life preserving composition present is that amount which in an effective combination of (a), (b) and (c) results in a shelf life extended beyond sixteen days for a bakery product prepared from the dough composition.

53. A bakery product composition in accordance with claim 52, wherein said bakery product is selected from at least one of bagels, English muffins, waffles, bread, French toasts, buns, doughnuts, quick bread, French bread, pumpernickel bread, sourdough bread, pancake, pizza crust, breadstick, brioche, rolls, cinnamon rolls, cookies, biscuits, crepes, croissants, shells, Danish dough, pie and tart shells, puff pastry, pastry, strudels, scones and vol-au-vent, corn yeast rolls, beer rolls, buttercakes, frosting, fudge, cakes, phyllo dough, yeast breads and cereal based food products.

54. A bakery product composition in accordance with claim 51 wherein said bakery product further comprises batter, dough, proofed/pre-proofed, par-baked, and baked products.

55. A bakery product composition in accordance with claim 54 wherein said bakery product is stored under frozen, refrigerated, and ambient conditions.

56. A bakery product composition in accordance with claim 55 wherein said effective amount of (a), (b) and (c) is in the range from about 0.617 to about 4.9 parts by weight dough.

57. A bakery product composition in accordance with claim 56 wherein said effective amount of (a), (b) and (c) ranges from about 0.654 to about 4.8 parts by weight dough.

58. A bakery product composition in accordance with claim 57 wherein said effective amount of (a), (b) and (c) ranges from about 0.691 to about 4.7 parts by weight dough.

59. A bakery product composition in accordance with claim 55 wherein said salts comprises an alkali metal salt.

60. A bakery product composition in accordance with claim 55 wherein said salt comprises an alkaline earth metal salt.

61. A bakery product composition in accordance with claim 55 wherein said salt is sodium acetate.

62. A bakery product composition in accordance with claim 55 wherein said salt is sodium propionate.

63. A bakery product composition in accordance with claim 55 wherein said salt is sodium sorbate.

64. A bakery product composition in accordance with claim 59 wherein said shelf life of said baked product is extended to about twenty-six days.

65. An additive composition useful for adding to a dough to extend the shelf life of a dough based product, said additive composition comprising:
(a) an effective amount of at least one salt of propionic, sorbic, phosphoric, citric, acetic, lactic and benzoic acid;
(b) an effective amount of at least one of guar gum, Arabic gum, xanthan gum and carboxymethylcellulose; and
(c) an effective amount of at least one enzyme selected from an amylase, protease, and pentosanase.

66. A bakery product composition in accordance with claim 65 wherein said effective amount of (a), (b) and (c) is in the range from about 0.728 to about 4.6 parts by weight dough.

67. A bakery product composition in accordance with claim 66 wherein said effective amount of (a), (b) and (c) ranges from about 0.765 to about 4.5 parts by weight dough.

68. A bakery product composition in accordance with claim 67 wherein said effective amount of (a), (b) and (c) ranges from about 0.802 to about 4.4 parts by weight dough.

69. A bakery product composition in accordance with claim 65 wherein said effective amount of (a), (b) and (c) ranges from about 0.84 to about 4.3 parts by weight dough.

70. A method of extending the shelf life of a dough based composition wherein said method comprises adding to said dough a shelf life extending additive composition comprising:
(a) an effective amount of at least one salt of propionic, sorbic, phosphoric, citric, acetic, lactic and benzoic acid;
(b) an effective amount of at least one of guar gum, Arabic gum, xanthan gum and carboxymethylcellulose; and
(c) an effective amount of at least one enzyme selected from an amylase, protease, and pentosanase.

71. A method in accordance with claim 70 wherein said admixture of (a), (b) and (c) admixed with said dough sequentially, serially or in combination.

72. A method in accordance with claim 71 wherein said (a), (b) and (c) are admixed together and added to said dough.

73. A bakery product having a shelf life of about 35 days.
